(19) United States
(12) Patent Application Publication
(10) Pub. No.: US 2023/0056391 A1
(43) Pub. Date: Feb. 23, 2023

(54) CALIBRATION OF AN IMAGE SCANNER IN A PRINTING SYSTEM

(71) Applicant: HEWLETT-PACKARD DEVELOPMENT COMPANY, L.P., Spring, TX (US)

(72) Inventors: Ferran OLIVERA CORPAS, Sant Cugat del Valles (ES); David PEINADO GUTIERREZ, Sant Cugat del Valles (ES); David VENDRELL TORNERO, Sant Cugat del Valles (ES)

(21) Appl. No.: 17/407,039

(22) Filed: Aug. 19, 2021

(51) Int. Cl. H04N 1/60; G01J 3/52; H04N 1/00

(52) U.S. Cl. CPC H04N 1/6044; H04N 1/6025; H04N 1/6008; G01J 3/524; H04N 1/6086; H04N 1/00087

(57) ABSTRACT

Aspects of the disclosure provide for a method. In some examples, the method includes printing a target plot comprising a color ramp, scanning the target plot via a first image scanner to determine first scan results indicating a relationship between a scanned measurement determined by the first image scanner and lightness of a scanned portion of the target plot, scanning the target plot via a second image scanner to determine second scan results indicating a relationship between a scanned measurement determined by the second image scanner and lightness of the scanned portion of the target plot, and determining a lookup table indicating a difference determined based on the first scan results and the second scan results.

### BACKGROUND

A printer may include a colorimeter to measure and determine an amount of light present in each third of a red-green-blue (RGB) color spectrum. For example, a beam of light may be directed at a substrate and an amount of RGB light reflected by the substrate may be measured by the colorimeter. Ink printed on the substrate may affect the RGB light reflected. The colorimeter may convert the measured light to any suitable color space. The measured light as represented in the color space may be used in various manners in the printing process.

### BRIEF DESCRIPTION OF THE DRAWINGS

Various examples will be described below referring to the following figures:

FIG. 1A is a perspective view diagram of a print system in accordance with various examples;

FIG. 1B is a perspective view diagram of a print system in accordance with various examples;

FIG. 2 is a diagram of a target plot in accordance with various examples;

FIG. 3 is a block diagram of a printer performing printer calibration in accordance with various examples;

FIG. 4 is a flowchart of a method in accordance with various examples;

FIG. 5 is a flowchart of a method in accordance with various examples; and

FIG. 6 is a diagram of a computer-readable medium storing executable code in accordance with various examples.

### DETAILED DESCRIPTION

Some print systems, or printers, may be large format printers. The print systems may include multiple image scanners arranged so as to provide scanning covered over a full width of a printing surface of the print system. The image scanners may be capable of performing certain image scanner functions, such as facilitating media scanning and/or copying. In some examples, the image scanner may also individually or collectively function as a colorimeter, or colorimeter sensor. The image scanners may be calibrated at a time of manufacturing of a print system to function as the colorimeter sensor. However, over time the image scanners may become inoperable such that at least some functionality of the print system is compromised. In such examples, it may be beneficial to replace the inoperable image scanner with a replacement image scanner. However, the replacement image scanner may not be calibrated to function as the colorimeter, resulting in decreased performance of the print system.

This disclosure describes a print system capable of performing in-printer calibration of a replacement image scanner as a colorimeter sensor. The print system may be capable of receiving a replacement image scanner that is not calibrated to function as a colorimeter sensor and calibrate the image scanner to function as a colorimeter sensor in conjunction with a second image scanner having been calibrated at a time of manufacturing, or at another time post manufacturing, of the print system to also function as a colorimeter sensor. In some examples, the print system may be provided with a target plot that includes a single set of color ramps. The target plot may have a width approximately equal to a width of, or suited for or to a width of, the replacement image scanner and the second image scanner. In at least some examples, the target plot is printed by the print system.

The target plot may be scanned by the second image scanner to form reference scan results and scanned by the replacement image scanner to form replacement scan results. The reference scan results may be converted according to a relationship between scanner measurements by the second image scanner and lightness of respective scanned portions of the target plot (e.g., a sensor to lightness (S2L) table of the second image scanner) to form reference lightness measurements. The replacement scan results may be compared to the reference lightness measurements to form a lookup table. For example, for each respective scanned portions of the target plot, the reference lightness measurement may be subtracted from the replacement scan result. The lookup table may indicate the difference between the replacement scan result and the reference lightness measurement for each respective scanned portion of the target plot. The difference indicated in the lookup table may indicate a modification to perform to scan results of the replacement image scanner to convert the scan results to lightness measurements. In at least some examples, modifying a scan result of the replacement image scanner according to the lookup table may result in the replacement image scanner providing a calibrated output (e.g., such as calibrated lightness measurements).

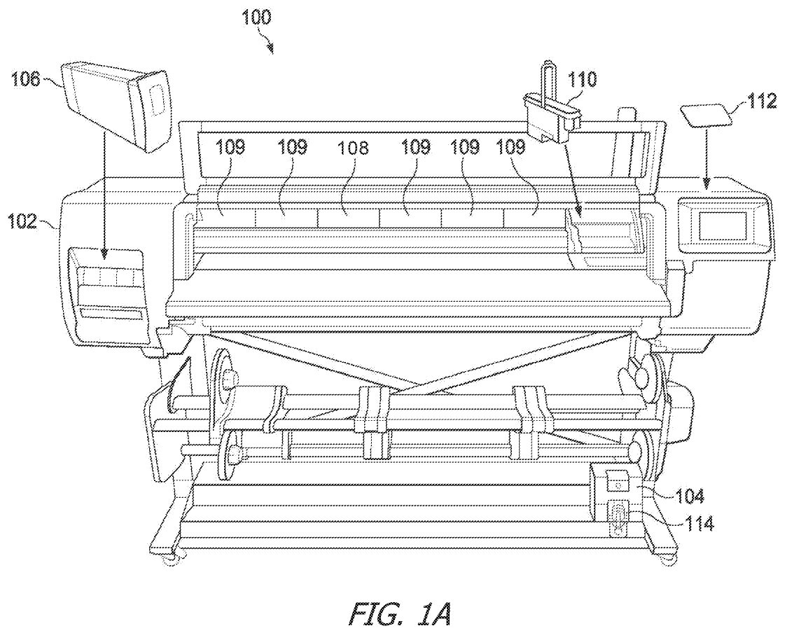

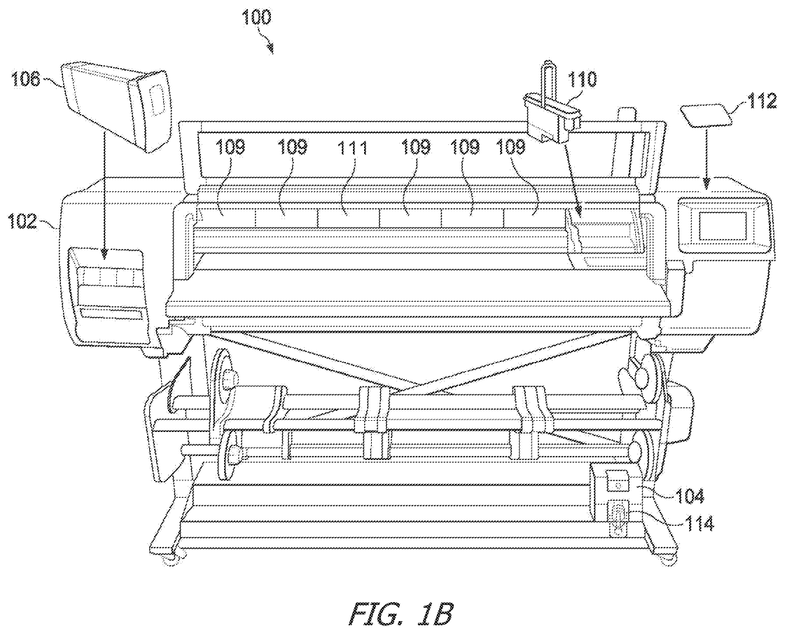

FIG. 1A is a perspective view diagram of a print system 100 in accordance with various examples. In at least some examples, the print system 100 may include a printer 102 and tank 104. The printer 102 may include an intermediate tank 106, an image scanner 108, image scanners 109, a print head 110, and a controller 112. In at least some examples, the print system 100 also includes a pump 114.

In at least some examples, the printer 102 transfers a print fluid, such as ink, from the intermediate tank 106 to the print head 110 for application on a substrate (not shown). In other examples, the print fluid may be a treatment fluid (e.g., pre- and/or post-printing fluid, a finishing fluid, etc.), or any other suitable fluid capable of being deposited or disposed on the substrate by the print head 110. The print head 110 may apply the print fluid to the substrate as an array or matrix of small dots of print fluid according to a pattern determined by the printer 102 (e.g., such as via the controller 112) or a pattern received by the printer 102 (e.g., such as from a computing device (not shown)). The print head 110 may deposit the print fluid on the substrate by any suitable process, such as a continuous ink system or process, a drop-on-demand process, a dye sublimation process, etc. The image scanners 109 may be substantially the same in function to the image scanner 108, and separate description of the image scanners 109 is omitted herein for ease of understanding.

The image scanner 108 may direct a beam of light at the substrate following deposition of print fluid on the substrate by the print head 110, or on a substrate having had print fluid previously deposited on the substrate (e.g., such as a substrate printed by a printer other than the printer 102). At least a portion of the beam of light may be reflected off of the print fluid back to the image scanner 108. The reflected light may include RGB components having values that vary according to the print fluid. For example, a color of the print fluid, a density of the print fluid, or other aspects of the print fluid may affect values of the RGB components of the reflected light that is reflected to the image scanner 108. The image scanner 108 may measure the reflected light to determine the RGB components. In at least some examples, the image scanner 108 may generate or form a scanned image file according to the reflected light. In some examples, the image scanner 108, or the controller 112, may convert the measurements, or the scanned image file, into a color space, such as a CIELAB color space or a color space indicating lightness values.

Because the image scanner 108 functions as a colorimeter, but is not itself actually a colorimeter, the image scanner 108 may not directly measure colors or lightness values. Instead, the image scanner 108 may obtain scan results that may be converted to color space measurements or lightness in the color space according to an S2L table. The S2L table may have values determined at a time of calibration of the image scanner 108, such as at a time of manufacturing of the print system 100, as described above. In at least some examples, the image scanner 108 and the image scanners 109 may have their own respective S2L tables with which they are uniquely associated.

As described above, in some circumstances, the image scanner 108 may fail to operate optimally. Such failure may manifest in a complete failure of the image scanner 108 to operate, or operation of the image scanner 108 at a level of performance deemed lesser according to any suitable metrics than a level of performance of the image scanner 108 at a time of manufacturing of the print system 100. In such circumstances, it may be beneficial to operation of the print system 100 to replace the image scanner 108 with a replacement image scanner.

FIG. 1B is a perspective view diagram of the print system 100 in accordance with various examples. In the print system 100 as shown in FIG. 1B, the image scanner 108 that has failed to operate optimally, as described above, has been replaced by an image scanner 111. The image scanner 111 may not be calibrated to function as a colorimeter (e.g., the image scanner 111 may not have an associated S2L table), but may be capable of such calibration. In at least some examples, to calibrate the image scanner 111 a target plot (not shown) is scanned by the image scanner 111 to form replacement scan results and one of the image scanners 109 to form reference scan results. In at least some examples, the reference scan results are deemed to represent true or accurate (e.g., calibrated) scan results for the target plot and the replacement scan results are deemed to represent inaccurate (e.g., uncalibrated) scan results for the target plot. The controller 112 may convert the reference scan results to reference lightness measurements and determine a variance between the replacement scan results and the reference lightness measurements and store the variance as the S2L table for the image scanner 111 in a non-volatile memory (not shown) of the printer 102.

In this way, subsequent scans by the image scanner 111 may be augmented or modified according to the newly stored S2L table for the image scanner 111 to provide calibrated scan results from the image scanner 111. Although the use of a single image scanner 109 of the image scanners 109 to form the reference scan results is described herein, multiple image scanners 109 may be used. For example, the target plot may be scanned by multiple of the image scanners 109 and resulting values converted to lightness measurements and averaged to form the reference lightness measurements. In at least some examples, such an approach may reduce sensitivity of the reference lightness measurements to signal noise or other errors that may occur in the image scanners 109 used to form the reference scan results and subsequent reference lightness measurements.

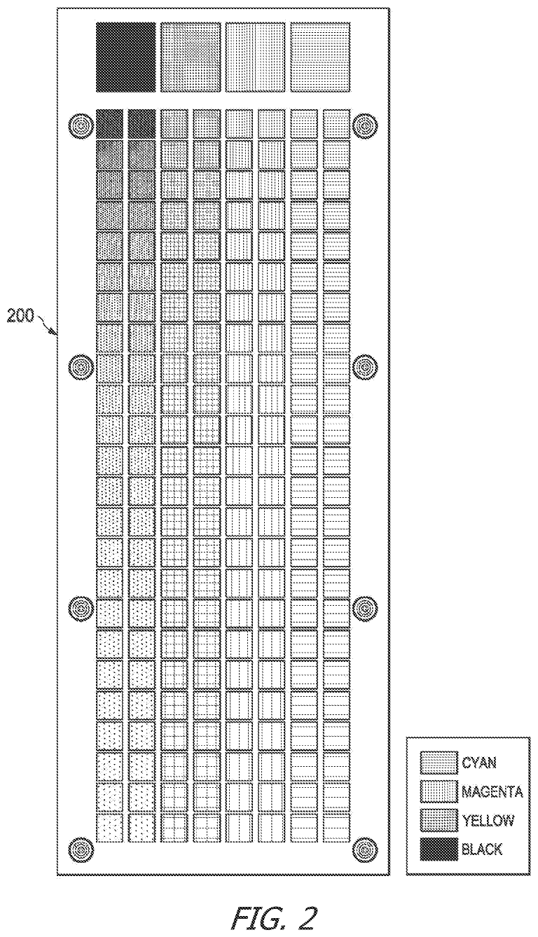

FIG. 2 is a diagram of a target plot 200 in accordance with various examples. In at least some examples, the target plot 200 is printed by the printer 102 of the print system 100 of FIG. 1A and/or FIG. 1B. Accordingly, reference may be made to components of FIG. 1A and/or FIG. 1B in describing the target plot 200. In other examples, the target plot 200 may be printed by any suitable printer, and not necessarily a printer which is under printer calibration according to this disclosure.

In at least some examples, the target plot 200 includes a plurality of color patches, with each color of ink provided by the printer 102 represented in the target plot 200. For example, if the printer 102 prints images according to deposition of cyan, magenta, yellow, and black (CMYK) ink, the target plot 200 may include cyan color patches, magenta color patches, yellow color patches, and black color patches. Each color may be represented in multiple print densities, opacities, or lightness. Such representation may be referred to as a color ramp. In other examples, the target plot may include any suitable number of colors and ink densities of those colors to form color ramps.

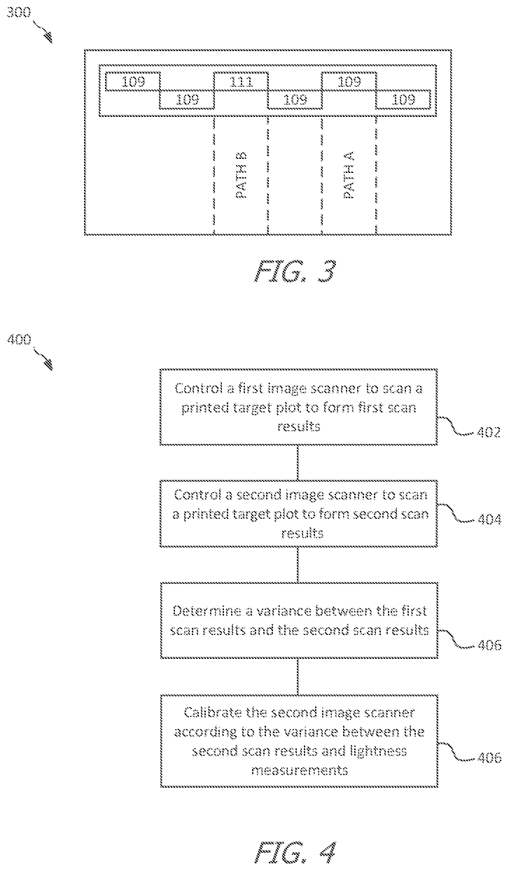

FIG. 3 is a block diagram 300 of a printer performing printer calibration in accordance with various examples. In at least some examples, the printer may be the printer 102, as described above, which may be calibrated according to the target plot 200, also as described above. Thus, reference may be made to components of other figures described above herein in describing the diagram 300.

The diagram 300 may be representative of a top-down view of a printing surface of the printer 102, the image scanners 109, and the image scanner 111. In at least some examples, a target plot, such as the target plot 200, is fed into the printer 102 to be scanned by one of the image scanners 109. A path along which the target plot is fed into the printer 102 is shown as “PATH A” in the diagram 300. While the diagram 300 shows the target plot being fed via PATH A to a particular one of the image scanners 109, in various examples the target plot may be fed to any one of the image scanners 109 that has been factory-calibrated for functioning as a colorimeter. In other examples, the target plot may be fed to any one of the image scanners 109 that has been previously calibrated according to any suitable process, including at least the teachings of this disclosure. In at least some examples, the image scanner 109 may obtain scanner measurements of the target plot (e.g., a scan result or reference scan result). The scanner measurements of the image scanner 109 may be converted to lightness measurements according to an S2L table associated with the image scanner 109.

The target plot may then be fed into the printer 102 to be scanned by the image scanner 111. A path along which the target plot is fed into the printer 102 is shown as “PATH B” in the diagram 300. In at least some examples, the image scanner 111 may obtain scanner measurements of the target plot (e.g., a scan result or replacement scan result). The scanner measurements of the image scanner 111 may be compared with the lightness measurements of the image scanner 109 to obtain an S2L table for the image scanner 111. For example, the scanner measurements of the image scanner 111 may be matched with the lightness measurements of the image scanner 109 by iterating over each color patch of the color ramps in the target plot, comparing scanner measurements with lightness. For example, outputs of the image scanner 109 and the image scanner 111 may each be stored by the printer 102 (e.g., via the controller 112) as image files. The controller 112 may analyze the image files according to any suitable computer vision process to determine numerical values based on the images to form the scanner measurements of the image scanner 109 and the image scanner 111, respectively. The controller 112 may convert the scanner measurements of the image scanner 109 to lightness measurements.

Based on the comparisons of the scanner measurements and lightness measurements, a variance between the lightness measurements of the image scanner 109 and the scanner measurements of the image scanner 111 may be determined. Based on this variance, the S2L table (which may be referred to as a look-up table) of the image scanner 111 may be determined. The S2L table of the image scanner 111 may be stored, such as for use subsequently by the image scanner 111.

While FIG. 3 describes the image scanner 109 first scanning the target plot followed by the image scanner 111 scanning the target plot, in various example operation may be reversed such that the image scanner 111 first scans the target plot, followed by the image scanner 109 scanning the target plot.

FIG. 4 is a flowchart of a method 400 in accordance with various examples. In at least some examples, the method 400 is implemented by a controller of a printer. In at least some examples, the printer may be the printer 102 and the controller may be the controller 112, each as described above, which may be calibrated according to the target plot 200, also as described above. Thus, reference may be made to components of other figures described above herein in describing the method 400. In at least some examples, the method 400 is a method for calibrating the printer 102, such as calibrating the image scanner 111.

At operation 402, a first image scanner of the printer is controlled to scan a printed target plot to form first scan results. The first image scanner may be an image scanner that has been previously calibrated for operation as a colorimeter. For example, the first image scanner may be one of the image scanners 109, calibrated at a time of manufacturing of the printer for functioning as a colorimeter. In another example, the first image scanner may be an image scanner calibrated for functioning as a colorimeter at some time other than a time of manufacturing of the printer. In at least some examples, the first image scanner may be controlled by the controller to scan the target plot. In at least some examples, the target plot is a CMYK color ramp.

At operation 404, a second image scanner of the printer is controlled to scan the printed target plot to form second scan results. In at least some examples, the second image scanner may be an image scanner not being calibrated for operation as a colorimeter. For example, the second image scanner may be the image scanner 111, which may be a replacement image scanner that has not been calibrated at a time of manufacturing of the printer for functioning as a colorimeter. In at least some examples, the second image scanner may be controlled by the controller to scan the target plot.

At operation 406, a variance between the first scan results and the second scan results is determined. In at least some examples, the variance is determined by iterating over each color patch of the color ramps in the target plot, comparing scanner measurements with lightness. For example, scanner measurements of the first image scanner may be converted to lightness measurements according to an S2L table of the first image scanner. The lightness measurements may be subtracted from the scanner measurements of the second image scanner for each color patch of the color ramps to determine the variance or difference.

At operation 408, the second image scanner is calibrated according to the determined variance. For example, based on the variance, an S2L table of the second image scanner may be determined. The S2L table of the second image scanner may be stored, such as for use subsequently by the second image scanner. In at least some examples, providing the S2L table of the second image scanner calibrates the second image scanner. The calibration may be at least partially based on the first image scanner.

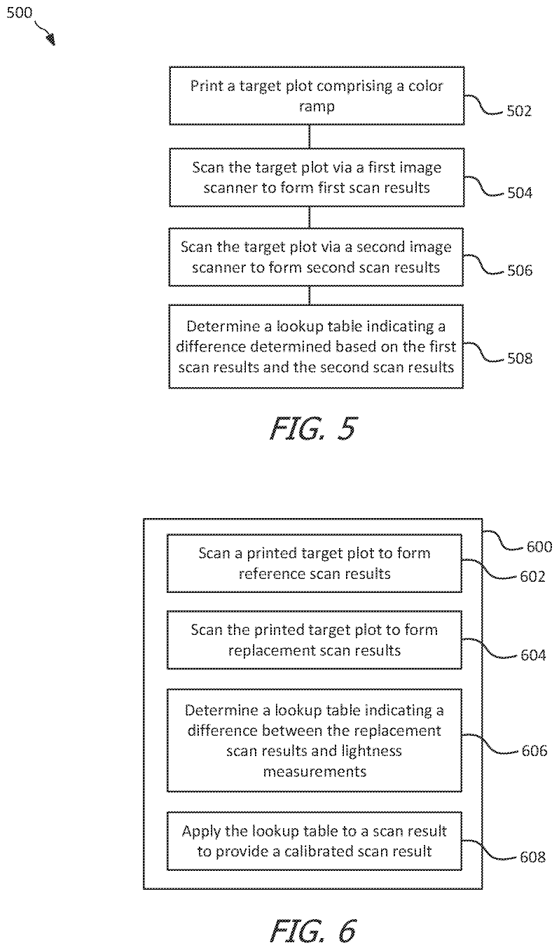

FIG. 5 is a flowchart of a method 500 in accordance with various examples. In at least some examples, the method 500 is implemented by a controller of a printer. In at least some examples, the printer may be the printer 102 and the controller may be the controller 112, each as described above, which may be calibrated according to the target plot 200, also as described above. Thus, reference may be made to components of other figures described above herein in describing the method 500. In at least some examples, the method 500 is a method for calibrating the printer 102, such as calibrating the image scanner 111.

At operation 502, a target plot comprising a color ramp is printed. The color ramp may be a CMYK color ramp. In some examples, the printing may be performed by a printer that will undergo calibration according to the target ramp. In other examples, the printing may be performed by a printer other than the printer that will undergo calibration according to the target ramp.

At operation 504, the target plot is scanned via a first image scanner to determine first scan results. In some examples, the first image scanner may be an image scanner that has been previously calibrated for operation as a colorimeter. For example, the first image scanner may be one of the image scanners 109, calibrated at a time of manufacturing of the printer for functioning as a colorimeter. In other examples, the first image scanner may be an image scanner not being calibrated for operation as a colorimeter. For example, the first image scanner may be the image scanner 111, which may be a replacement image scanner that has not been calibrated at a time of manufacturing of the printer for functioning as a colorimeter. In at least some examples, the first image scanner may be controlled by the controller to scan the target plot. The first scan results may be converted according to an S2L table of the first image scanner to determine lightness measurements of the first image scanner, such as if the first image scanner has previously been calibrated for operation as a colorimeter.

At operation 506, the target plot is scanned via a second image scanner to determine second scan results. In some examples, the second image scanner may be an image scanner not being calibrated for operation as a colorimeter. For example, the second image scanner may be the image scanner 111, which may be a replacement image scanner that has not been calibrated at a time of manufacturing of the printer for functioning as a colorimeter. In other examples, the second image scanner may be an image scanner that has been previously calibrated for operation as a colorimeter. For example, the second image scanner may be one of the image scanners 109, calibrated at a time of manufacturing of the printer for functioning as a colorimeter. In at least some examples, if the first image scanner is one of the image scanners 109, the second image scanner is the image scanner 111. Conversely, if the first image scanner is the image scanner 111, the second image scanner is one of the image scanners 109. In at least some examples, the second image scanner may be controlled by the controller to scan the target plot. The second scan results may be converted according to an S2L table of the second image scanner to determine lightness measurements of the second image scanner, such as if the second image scanner has previously been calibrated for operation as a colorimeter.

At operation 508, a lookup table is determined indicating a difference between the first scan results and the second scan results, where one of the first scan results or the second scan results have been converted to lightness measurements as described above. The lookup table, in at least some examples, may be an S2L table of an image scanner being calibrated (e.g., either the first image scanner or the second image scanner, as described above). The lookup table, in at least some examples, may enable the image scanner being calibrated to provide calibrated scan results.

FIG. 6 is a diagram of a computer-readable medium 600 storing executable code. In at least some examples, the computer-readable medium 600 is non-transitory in nature and the executable code is machine-executable. When executed, such as by a controller, such as the controller 112 of FIG. 1A and/or FIG. 1B, of a printer, the executable code causes the controller to perform functions or operations. In at least some examples, the executable code is representable as instructions. In some examples, the executable code may cause the controller to calibrate a replacement image scanner.

In at least some examples, instruction 602 causes the controller to control a reference image scanner of the printer to scan a printed target plot to form reference scan results. The reference image scanner may be an image scanner that has been previously calibrated for operation as a colorimeter. For example, the reference image scanner may be one of the image scanners 109, calibrated at a time of manufacturing of the printer for functioning as a colorimeter. In at least some examples, the target plot is a CMYK color ramp.

In at least some examples, instruction 604 causes the controller to control the replacement image scanner of the printer to scan the printed target plot to form replacement scan results. In at least some examples, the replacement image scanner may be an image scanner not being calibrated for operation as a colorimeter. For example, the replacement image scanner may be the image scanner 111, which may be a replacement image scanner that has not been calibrated at a time of manufacturing of the printer for functioning as a colorimeter.

In at least some examples, instruction 606 causes the controller to determine a lookup table based on the reference scan results and the replacement scan results. For example, the controller may convert the reference scan results to lightness measurements and determine the lookup table according to a difference between the replacement scan results and the lightness measurements. The lookup table, in at least some examples, may be an S2L table of the replacement image scanner. The lookup table, in at least some examples, may enable the replacement image scanner to provide calibrated scan results. In at least some examples, instruction 608 causes the controller to apply the lookup table to a scan result of the replacement image scanner to provide a calibrated scan result of the replacement image scanner, calibrated according to the reference image scanner.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

1. A printer, comprising:
a controller to:
control a first image scanner of the printer to scan a printed target plot to form first scan results, the first image scanner having been previously calibrated to operate as a colorimeter sensor;
control a second image scanner of the printer to scan the printed target plot to form second scan results, the second image scanner being a replacement image scanner which is not initially calibrated to operate as a colorimeter sensor;
convert the first scan results to lightness measurements;
determine a variance between the second scan results and the lightness measurements; and
calibrate the second image scanner to operate as a colorimeter sensor according to the variance between the second scan results and the lightness measurements.

2. The printer of claim 1, wherein the controller is to control the printer to print the target plot.

3. The printer of claim 1, wherein the controller is to convert the first scan results to the lightness measurements according to a sensor to lightness table of the first image scanner.

4. The printer of claim 1, wherein the controller is to generate a sensor to lightness table of the second image scanner according to the variance between the second scan results and the lightness measurements.

5. The printer of claim 4, wherein the controller is to control the second image scanner to:
scan an image to form third scan results; and
convert the third scan results to second lightness measurements according to the sensor to lightness table of the second image scanner.

6. A method, comprising:
printing a target plot comprising a color ramp;
scanning the target plot via a first image scanner to determine first scan results indicating a relationship between a scanned measurement determined by the first image scanner and lightness of a scanned portion of the target plot, the first image scanner having been previously calibrated to operate as a colorimeter sensor;
scanning the target plot via a second image scanner to determine second scan results indicating a relationship between a scanned measurement determined by the second image scanner and lightness of the scanned portion of the target plot, the second image scanner not initially calibrated to operate as a colorimeter sensor;
determining a lookup table indicating a difference determined based on the first scan results and the second scan results; and
calibrating the second image scanner to operate as a colorimeter sensor based on the lookup table.

7. The method of claim 6, wherein the lookup table is a sensor to lightness table of one of the first image scanner or the second image scanner.

8. The method of claim 7, wherein sensor measurements of the one of the first image scanner or the second image scanner are calibrated according to the lookup table.

9. The method of claim 6, wherein the color ramp is a cyan-magenta-yellow-black color ramp.

10. The method of claim 6, further comprising:
converting the first scan results to lightness measurements according to a sensor to lightness table of the first image scanner; and
determining the lookup table according to a difference between the second scan results and the lightness measurements.

11. A non-transitory computer-readable medium storing executable code for calibrating a replacement image scanner, which, when executed by a controller of a printer, causes the controller to:
control a reference image scanner of the printer to scan a printed target plot to form reference scan results;
control the replacement image scanner of the printer to scan the printed target plot to form replacement scan results, the replacement image scanner not being initially calibrated to operate as a colorimeter sensor;
convert the first scan results to lightness measurements;
determine a lookup table indicating a difference between the replacement scan results and the lightness measurements; and
calibrate the replacement image scanner to operate as a colorimeter sensor based on the lookup table, the lookup table to be applied to a scan result of the replacement image scanner to provide a calibrated scan result of the replacement image scanner, calibrated according to the reference image scanner.

12. The non-transitory computer-readable medium of claim 11, wherein the printed target plot is a cyan-magenta-yellow-black color ramp.

13. The non-transitory computer-readable medium of claim 11, wherein the lookup table is a sensor to lightness table of the replacement image scanner.

14. The non-transitory computer-readable medium of claim 11, wherein, to determine the lookup table, the controller is to convert the reference scan results to the lightness measurements according to a sensor to lightness table of the reference image scanner.

15. The non-transitory computer-readable medium of claim 11, wherein the controller is to apply the lookup table to the scan result to convert the scan result to a second lightness measurement according to the lookup table.

16. The printer of claim 1, wherein the controller is to identify the second image scanner as a replacement image scanner.

17. The printer of claim 1, wherein the controller is to generate a new look-up table for the replacement image scanner to calibrate the replacement image scanner to operate as a colorimeter sensor.

18. The printer of claim 1, wherein the first image scanner and the second image scanner are arranged at different locations in width direction of a printing surface.

19. The printer of claim 1, wherein:
the second image scanner does not initially operate based on a sensor-to-lightness (S2L) table, and
the controller is to generate an S2L table for the second image scanner according to the variance between the second scan results and the lightness measurements, the second image scanner to operate as a colorimeter sensor using the S2L table.

20. The printer of claim 18, further comprising:
a storage area to store the S2L table for access by the controller to calibrate the second image sensor to operate as a colorimeter sensor.
